(19) United States
(12) Patent Application Publication
(10) Pub. No.: US 2010/0278360 A1
(43) Pub. Date: Nov. 4, 2010

(54) METHOD AND SUPPORT SYSTEM FOR PRESENTING ELECTROPHYSIOLOGICAL MEASUREMENTS

(75) Inventor: Kevin T. Dolan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/811,836

(22) PCT Filed: Jan. 6, 2009
(86) PCT No.: PCT/IB2009/050024

§ 371 Date: Jul. 7, 2010

(30) Foreign Application Priority Data
Jan. 11, 2008 (EP) 08150188.4

(51) Int. Cl. G09F 27/00

(52) U.S. Cl. 381/124

(57) ABSTRACT

A method (40) and system (10) of presenting an electrophysiological signal, the method comprising receiving (41) the electrophysiological signal, extracting (42) different components from the received electrophysiological signal, processing (43) the different components to generate different audio signals corresponding to the respective different components, and audibly presenting (44) the different audio signals. Each component represents an activity of atleast one physiological unit.

### FIELD OF THE INVENTION

This invention relates to a method of presenting an electrophysiological signal, the method comprising receiving the electrophysiological signal, processing the received electrophysiological signal to generate audio signals corresponding to the received electrophysiological signal and audibly presenting the audio signal.

This invention further relates to a support system for assisting in reading an electrophysiological signal.

### BACKGROUND OF THE INVENTION

Electrophysiology generally involves placing electrodes into biological tissue of living organisms or into excised tissue. Common electrophysiological measurements are made in, e.g., brain or muscle tissue, but also other types of tissue may be subject to electrophysiological measuring. In the following, as an example, electrophysiological measurements in the brain are discussed. It is however to be noted that the described techniques are also applicable to other electrophysiological measurements.

When performing neurosurgical procedures such as chronic electrode implantation for deep brain stimulation, imaging done prior to implantation is often not sufficient for accurate localization of the target. It is typically necessary to also make measurements of the neural activity in the vicinity of the predicted target location, and from the characteristics of this activity, determine when the desired target has been reached. This is particular important in the case of deep brain stimulation, where it is not only necessary to analyze the measurements of neural activity to determine the functional anatomy for target location, but also to determine which of the many implanted electrodes (which in current procedures is typically four), should be used for stimulation.

In many cases the procedure for doing this relies almost entirely on the experience and observation skills of the electrophysiologist. He looks at simple time-courses of the measured signals and/or listens to the signals played through a speaker as sound. Based on his own experience and knowledge of what the signals typically look or sound like in various anatomical regions, he then attempts to determine the functional anatomy from the measured signals. This procedure is very time consuming, often accounting for a large portion of the total time required for implantation, and is especially uncomfortable for the patient, since they must be awake and alert during this portion of the procedure.

Signal processing packages exist which attempt to aid the electrophysiologist in this task. Most of these packages use the approach of simply providing the electrophysiologist with a collection of standard signal processing tools that he can apply to the signals, such as spectral analysis, spike sorting, and spike interval statistics. Another approach is for the software to try to make the determination of functional anatomy itself. Both of these approaches have met with little success.

The task of attempting to determine the functional anatomy from measured electrophysiological signals is a very time consuming one. This not only adds to the expense, risk, and discomfort of the procedure, but it also has the effect of limiting the number of candidates for such procedures, because many patients who could potentially benefit from such implants are not physically able to handle the operation. In addition, the process of determining the functional anatomy is a complex, and highly subjective task, which requires an extremely experienced electrophysiologist to do properly. A surgical support system that simplifies the task of determining the functional anatomy and localizing the target, is therefore of critical importance for reducing the time required for the surgery, making such procedures feasible for a larger number of surgical teams, and improving the accuracy of target localization.

Simply extracting statistical properties of the data and presenting those figures to the electrophysiologist provides very little actual benefit. Such figures tend to vary greatly from case to case, and the time necessary to look through all of the results, interpret them, and come to a conclusion, becomes prohibitive in a surgical environment. The features that an experienced electrophysiologist is keying into when he assesses (either visually or audibly) the signals are rather subtle patterns and regularities in the signals that are quite difficult to assess in a formal computational manner. Without a deep understanding of the relationships between the statistical measures provided by a support system and the visual or audible features that an experienced electrophysiologist is keying into, such measures are extremely difficult for the electrophysiologist to incorporate into his assessment. In most cases, the judgement ends up being made on the basis of his subjective assessment alone, with the additional statistical measures provided by the support system being given little if any weight in the overall judgement.

This also poses a serious problem for the approach of automating the determination of functional anatomy, because it is a daunting task to even come close to the ability of an experienced human being to detect these subtle features, much less surpass that ability.

### OBJECT OF THE INVENTION

It is an object of the invention to provide a method or a system for presenting an electrophysiological signal in such a way that the electrophysiologist can quickly and intuitively understand the information.

### SUMMARY OF THE INVENTION

According to a first aspect of the invention, this object is achieved by providing a method of presenting an electrophysiological signal, the method comprising receiving the electrophysiological signal, extracting different components from the received electrophysiological signal, each component representing an activity of at least one physiological unit, processing the different components to generate different audio signals corresponding to the respective different components, and audibly presenting the different audio signals.

When using this method, the electrophysiologist will be allowed to listen to the activity of individual physiological units. In known systems and methods, the physiologist was only allowed to listen to signals coming from one or more electrodes and representing an overall activity of a combination of different physiological units. With the method according to the invention it is easier to make a quick and reliable assessment of the electrophysiological signals and to judge the physiological state of the inspected subject. Many techniques are available for presenting different audio signals. Some of these techniques will be described below.

The different components from the electrophysiological signal may, e.g., comprise background noise, action potentials or action potentials from a specific physiological unit.

According to an embodiment of the method according to the invention, the processing comprises applying different gains to the different audio signals. E.g. a higher gain may be used for the background noise than for the action potentials, in order to make it easier to derive important informative from the background noise. Alternatively, the background noise may get a lower gain or may even be removed completely (zero gain), for emphasizing other signals. Also components from some physiological units may be emphasized by having a higher gain than others. Preferably, the relative gains of all components are adjustable by the user or via an automated and or predetermined process. In another method according to the invention, the processing comprises assigning a position to each one of the different audio signals and the audibly presenting comprises using 3D positional audio algorithms for presenting the audio signals as if coming from the respective assigned positions.

In a basic embodiment, a first signal corresponding to a specific physiological unit is presented by a left speaker while a second signal corresponding to another physiological unit is presented by a right speaker. In more advanced embodiments, the 3D positional audio system may position multiple different physiological units at different angles and distances from the viewpoint of the user.

These and other aspects of the invention are apparent from and will be elucidated with reference to the embodiments described hereinafter.

### BRIEF DESCRIPTION OF THE DRAWINGS

In the drawings:

FIG. 1 schematically shows an electrophysiological measurement system according to the invention,

FIG. 2 schematically shows an electrophysiological measurement system with a mixer stage,

FIG. 3 schematically shows an electrophysiological measurement system comprising a 3D positional audio output, and

FIG. 4 shows a flow diagram of a method according to the invention.

### DETAILED DESCRIPTION OF THE INVENTION

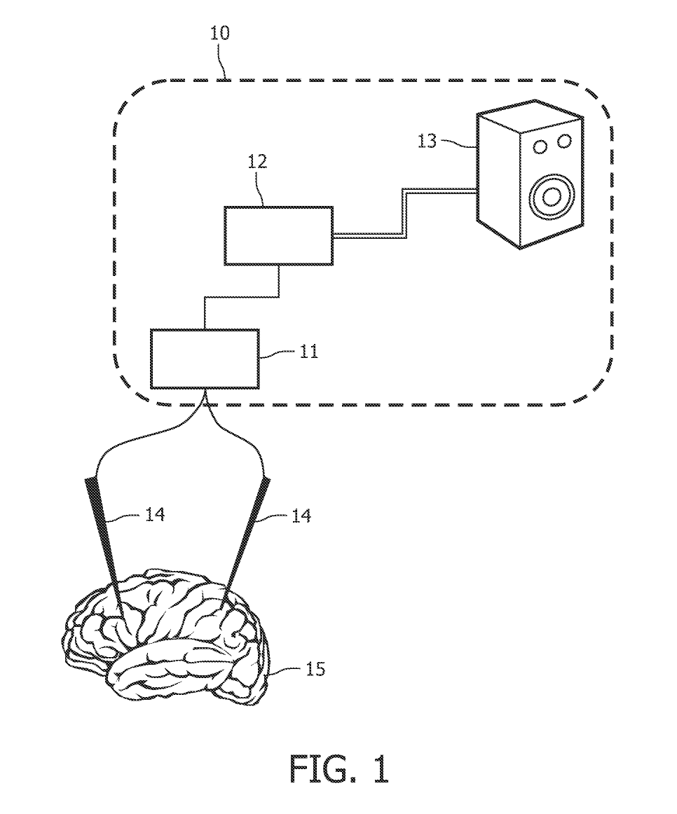

FIG. 1 schematically shows an electrophysiological measurement system 10 according to the invention. The system 10 is used for measuring neural activity in specific locations of a human brain 15. Two electrodes 14 have been implanted into the brain 15 for acquiring electrophysiological readings. The acquired signals are received at an input 11 of the system 10 and passed on to a processor 12.

The processor 12 processes the received signals in order to extract different components from the received electrophysiological signal, each component representing an activity of at least one physiological unit of the brain 15. A physiological unit may, e.g., be a single brain cell or a particular axon. In electromyography, a component may represent the activity of one motor unit. Some components may be extracted from one input signal only. Other components may be derived from a combination of signals obtained from separate electrodes. The processor 12 may also be arranged to extract a component representing activity in more than one brain cell. For example, signals from spatially or functionally related brain cells may be combined in one component. Often, the background signal also comprises important information for the electrophysiologist and it may thus be useful to provide the background signal in one or more of the different components. Background signals may, e.g., originate from action potentials from multiple physiological units lying further away from the electrodes.

After extracting the different components from the input signals, the processor 12 generates different audio signals corresponding to the respective different components. The separate audio signals are then presented using at least one speaker 13. The separate audio signals are presented in such a way that the electrophysiologist is able to easily interpret the information comprised in the different components and to discriminate between signals from different physiological units. For example, different components are not presented together but sequentially. The order in which the different components are presented may be configured by the user of the system. Alternatively, different filters may be applied to different components, only a predetermined set of audio signals may be presented or some audio signals may undergo more amplification than other components. Preferably the presentation is also such that information can be derived from a combination of two or more of the separate signals in an easy and intuitive way.

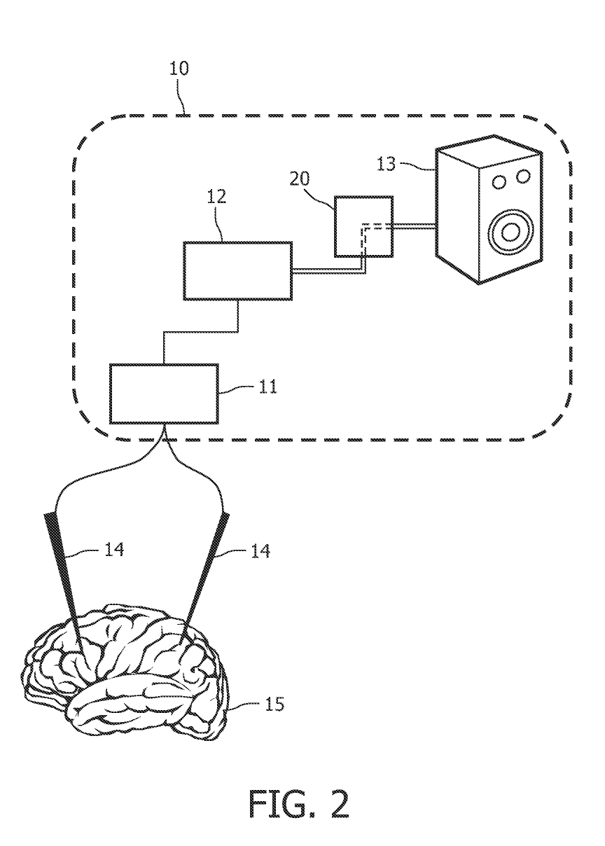

FIG. 2 schematically shows an electrophysiological measurement system 10 with a mixer stage 20. This embodiment is very similar to the embodiment shown in FIG. 1. The main addition with respect to the embodiment of FIG. 1 is that the system 10 further comprises a mixer stage 20 for mixing the different audio signals. The mixer stage 20 is used for mixing the different audio signals coming from the processor 12. At the mixer stage 20, some or all of the different audio signals may be selected for being presented to the user via one or more speakers 13. The mixer stage 20 may apply some delay to selected audio signals in order to present the audio signals sequentially or to enable investigating timing relations between different signals. The mixer stage 20 may also apply different filters to different audio signals, depending on the type of information represented by the signal. An important feature of the mixer stage 20 is that different gains may be applied to different audio signals, making it easier for the user to concentrate on specific aspects of the measured electrophysiological signal. Preferably, the system 10 allows listening to the same signal repeatedly, each time changing the ratio of the gains for different audio signals. Preferably, all settings of the mixer stage 20 are user controllable, but part or all may also be controlled (semi-)automatically according to pre-programmed schemes. Different techniques for transforming and/or selecting the different audio signals may of course be combined.

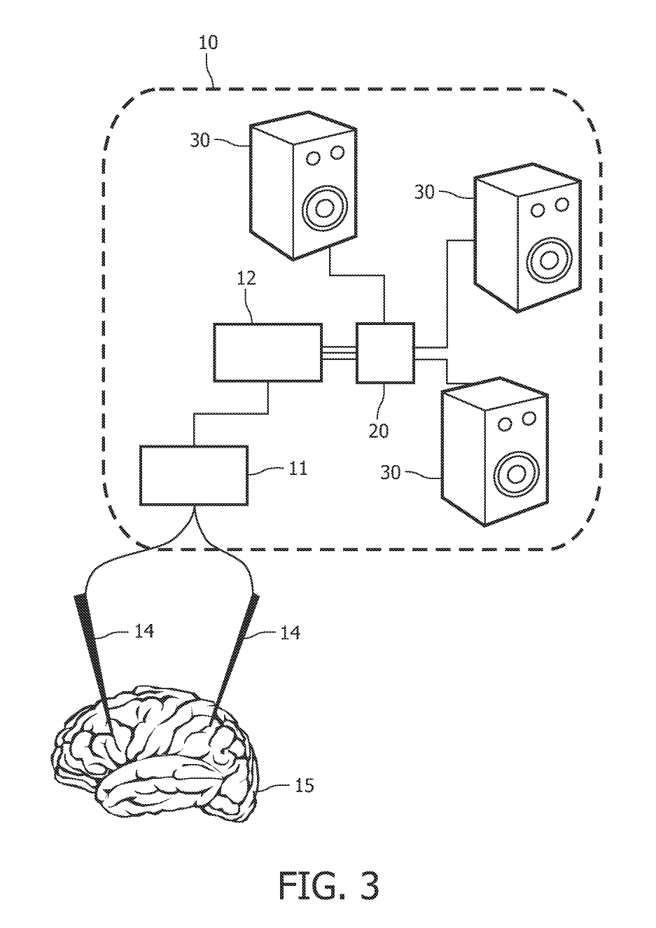

FIG. 3 schematically shows an electrophysiological measurement system 10 comprising a 3D positional audio output 30. In this example, the audio output is provided by a set of three different speakers 30 which are provided at different positions. The mixer stage 20 sends the audio signals coming from the processor 12 to different speakers 30, such that some signals appear to originate from one position and other signals from other positions. The distribution of the audio signals over the speakers 30 may be such that one audio signal is sent to two or more speakers 30, possibly with different gains or other properties. Before sending different signals to different speakers 30, first a (fictitious) position should be assigned to each signal. The assigning of positions to the audio signals may be performed by the processor 12 or at the mixer stage 20. Then it is computed how the audio signal should be distributed over the different speakers 30 in order to give the impression that the signals originate from the assigned positions. It is to be noted that the impression of different signals originating from different positions may also be realized using special audio processing techniques for providing 3D positional audio using only one or two speakers 30. An example of such a technique uses a so-called head-related transfer function, whereby parameters of the audio signals are given values that correspond with the natural 3D perception of signal by the user. These parameters imitate among others, the diffraction and reflection properties of the head, pinna and torso, before the signal reaches the eardrum and inner ear.

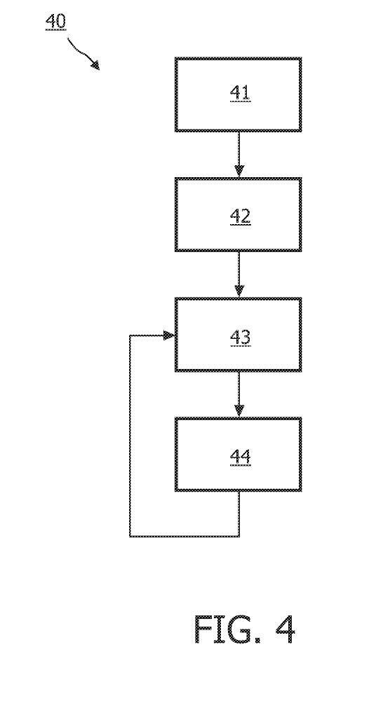

FIG. 4 shows a flow diagram of a method 40 according to the invention. The method comprises a step of receiving 41 the electrophysiological signal, a step of extracting 42 different components from the received electrophysiological signal, each component representing an activity of at least one physiological unit, a step of processing 43 the different components to generate different audio signals corresponding to the respective different components, and a step of audibly presenting 44 the different audio signals. The steps of processing 43 and presenting 44 may be repeated for allowing the user to listen to the same signals multiple times, but presented in a different way. The complete method is continuously repeated as long as measurement signals come from the measurement electrodes 14. The method of FIG. 4 may be performed by the systems 10 shown in FIGS. 1 to 3.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer executable instructions, for example processor instructions and/or interpreter instructions (e.g. Java interpreter instructions). Alternatively, one or more or all of the subroutines may be stored in at least one external library file and linked with a main program either statically or dynamically, e.g. at run-time. The main program contains at least one call to at least one of the subroutines. Also, the subroutines may comprise function calls to each other. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. These instructions may be subdivided into subroutines and/or be stored in one or more files that may be linked statically or dynamically.

The carrier of a computer program may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method (40) of presenting an electrophysiological signal, the method comprising:
receiving (41) the electrophysiological signal,
extracting (42) different components from the received electrophysiological signal, each component representing an activity of at least one physiological unit,
processing (43) the different components to generate different audio signals corresponding to the respective different components, and
audibly presenting (44) the different audio signals.

2. A method (40) of presenting an electrophysiological signal according to claim 1, wherein the processing (43) comprises applying different gains to the different audio signals.

3. A method (40) of presenting an electrophysiological signal according to claim 2, wherein the applying different gains and the audibly presenting the different audio signals are repeated at least once with different relative gains for the different audio signals.

4. A method (40) of presenting an electrophysiological signal according to claim 1, wherein the processing (43) comprises applying different filters to the different audio signals.

5. A method (40) of presenting an electrophysiological signal according to claim 1, wherein the processing (43) comprises assigning a position to each one of the different audio signals and the audibly presenting (44) comprises using 3D positional audio algorithms for presenting the audio signals as if coming from the respective assigned positions.

6. A method (40) of presenting an electrophysiological signal according to claim 1, wherein one component of the different components comprises a background noise.

7. A method (40) of presenting an electrophysiological signal according to claim 1, wherein one component of the different components comprises at least one individual action potential.

8. A method (40) of presenting an electrophysiological signal according to claim 1, wherein one component of the different components comprises multiple action potentials from a single physiological unit.

9. A support system (10) for assisting in reading an electrophysiological signal, the support system (10) comprising:
an input (11) for receiving the electrophysiological signal
a processor (12) being operative to
extract different components from the received electrophysiological signal, each component representing an activity of at least one physiological unit, and
generate different audio signals corresponding to the respective different components, and
an audio output (13, 30) for audibly presenting the different audio signals.
